(19) United States
(12) Patent Application Publication
(10) Pub. No.: US 2025/0354907 A1
(43) Pub. Date: Nov. 20, 2025

(54) COOLABLE CARRIER, DEVICE, AND METHOD FOR PRODUCING FROZEN SAMPLE SPHERES

(71) Applicant: Applyo Jena GmbH, Jena (DE)

(72) Inventors: Hanno Hermann, Jena (DE); Thanh Tu Hellmich-Duong, Jena (DE); Irene Helbing, Weimar (DE)

(21) Appl. No.: 19/281,349

(22) Filed: Jul. 25, 2025

Related U.S. Application Data
(63) Continuation of application No. PCT/EP2024/051854, filed on Jan. 26, 2024.

(30) Foreign Application Priority Data
Jan. 26, 2023 (DE) 10 2023 101 970.8

(51) Int. Cl. G01N 1/42

(52) U.S. Cl. CPC G01N 1/42

(57) ABSTRACT

A coolable carrier includes at least one structured face having a plurality of receiving structures, each of which can be used to receive and position a liquid sample, and wherein each receiving structure has a recess, in particular a concave recess. At least some of the receiving structures are separated from the structured face by virtue of the fact that the receiving structures each project beyond a surface of the structured face directly surrounding the receiving structures. A method is for making frozen sample spheres.

### CROSS-REFERENCE TO RELATED APPLICATIONS

This application is a continuation application of international patent application PCT/EP2024/051854, filed Jan. 26, 2024, designating the United States and claiming priority from German application 10 2023 101 970.8, filed Jan. 26, 2023, and the entire content of both applications is incorporated herein by reference.

### BACKGROUND

In the following, the term cryo-beads refers in particular to spherical frozen solutions (sample spheres) containing different active ingredients, in particular therapeutic active ingredients, excipients, enzymes, proteins, genetic material, in particular portions of DNA and/or RNA, primers or oligonucleotides, salts, organic substances, complexes and/or other substances or molecules, vesicles, chromosomes, cell organelles and complete cells, here also referred to as reagent mixture. After their production, the cryo-beads can advantageously be preserved even at ambient temperatures above their particular freezing temperature by removing the water contained in the cryo-beads.

The advantage of such dried cryo-beads lies in the transportability of originally sensitive materials without the mandatory maintenance of cold chains and thus their usability even in processes and/or laboratories in countries with incomplete or no cooling infrastructure.

In order to achieve the best possible ratio of mechanical stability and volume to the surface area of such cryo-beads, they are manufactured as spheres whenever possible. In this form, both the cryo-beads and their dried forms (lyo-beads) are most stable against mechanical stress and, due to their compact shape, can be easily transported and used without loss of material due to abrasion and in a space-saving manner.

There are essentially three methods known from the prior art for the production of cryo-beads. Following a first methodology, ice particles, for example, dry ice pellets, are pressed into spheres or pellets using punches or pairs of punches and dies. However, this method is technologically difficult to control for use in the pharmaceutical and diagnostic environment.

When using a second manufacturing method, a reagent mixture is frozen in or on liquid nitrogen or other cryogenic liquids, for example silicone oils. If the amount of drops of the reagent mixture is sufficiently small, the liquid drops initially float on the evaporating nitrogen and solidify into a spherical shape due to the “inverse Leidenfrost effect.” As the liquid drops cool, the temperature difference from the still boiling nitrogen decreases, so that the drops sink. If the liquid drop is too large or too heavy, the evaporating nitrogen does not hold the drop on the surface. As it sinks down, the liquid solidifies into a drop shape. This is in particular true for non-boiling cryogenic liquids such as silicone oil.

As a result of the boiling of nitrogen, small volumes, so-called “satellite droplets,” can be detached from a still liquid drop, which leads to an undesirable and uncontrollable decrease in the volume of the drop. As a result of the boiling nitrogen, the drops floating on the nitrogen vapor move back and forth and, when they collide with other drops, merge into an undesirably large drop. This results in a mixture of unequally sized beads, that is, an inhomogeneous size distribution of the beads. In addition, before they are completely frozen, the drops come into direct contact with the nitrogen and any impure substances or agents that may contaminate the product.

In a third approach, drops of the solution to be processed to form the cryo-bead are applied to an (ultra) cold plate, whereupon they freeze. In order to support a spherification of the drops (that is, shaping into spheres), the plate can have repellent, in particular hydrophobic, properties at least in the relevant regions of its surface. Typically, this method produces hemispheres, spherical segments, or flattened, elliptical lenses rather than true spherical shapes. The cryo-beads produced on a plate must then be mechanically removed from the plate, whereby the individual cryo-beads can easily be damaged and then no longer have the desired shape and contain the desired amount of reagent mixture.

Examples of the production and optionally of the drying of the cryo-beads can be found in the documents U.S. Pat. No. 4,848,094, US 2014/0294872 A1, US 2016/0252300 A1, WO 2009/092703 A1, WO 2010/125087 A1 and WO 2013/066769 A1.

### SUMMARY

The disclosure is based on the object of proposing an improved possibility for the production of frozen sample spheres. The object of the disclosure is to provide device-related and method-related possibilities for achieving the object.

The coolable carrier includes at least one face structured having a plurality of receiving structures, each of which serves to receive and position a predetermined amount, for example an aliquot, of a liquid sample, hereinafter referred to simply as “sample.” The term liquid sample includes not only aqueous solutions of various viscosities but also gels, in particular if they can assume a spherical shape (sphere) under suitable conditions due to their molecular interactions. Each receiving structure has a recess that is, in particular, concave. The receiving structures are configured in such a way that they have a certain receiving capacity relative to the sample in question (reagent mixture) and prevent it from flowing away or rolling away in an undesired manner. It is characteristic that at least some of the receiving structures are separated from the structured face by each projecting over a surface of the structured face directly surrounding them. Furthermore, at least some of the receiving structures can optionally have a coating and/or surface structure that is slightly to moderately repellent to the sample, that is, in particular hydrophobic, over the region by which they come into direct contact with the sample in order to support the formation of a sphere and to achieve a large contact angle between the sample and the surface of the carrier. The dimension of the recess also determines the positioning of the still liquid sample, in particular, and represents a mechanical spatial resistance against the sample rolling away.

Particularly suitable materials for the carrier are those that allow effective cooling of the receiving structures, for example metals and metallic alloys, composites, in particular with metallic layers, that is, materials with the highest possible thermal conductivity.

In further embodiments of the carrier according to the disclosure, the region of the face surrounding a recess is also provided with a (hydrophobic) coating and/or surface configuration that achieves the largest possible contact angle between the reagent mixture and the surface.

In a further embodiment, there is a peripheral edge around each of the recesses present in the structured face. The edge protrudes beyond the structured face.

The recess itself advantageously has the shape of a spherical segment to support the formation of a sphere. The spherical segment is characterized by the radius of the corresponding sphere and the height of the spherical segment. If the height of the spherical segment is equal to the radius of the sphere, the spherical segment corresponds to a hemisphere. In preferred embodiments, the spherical segment is shallower than a hemisphere, that is, the ratio of the height of the spherical segment to the radius of the sphere is less than 1, in order to simplify removal of the cryo-beads. In particularly preferred embodiments, the ratio of the height of the spherical segment to the radius of the sphere is less than 0.7. More preferably, the ratio of the height of the spherical segment to the radius of the sphere is less than 0.4.

The receiving structures released from the structured face advantageously protrude at least 1 nm, preferably at least 0.1 μm, particularly preferably at least 1 μm above the surface of the structured face directly surrounding them.

For this purpose, a recess or trench can be created around some or all of the receiving structures using an abrasive method such as milling or spark erosion (sinking, drilling, wire erosion, et cetera). As a result of the exposure created in this way, the receiving structures include a carrier structure at the base, for example in the form of a column. The column can, for example, have a round, oval or n-sided cross section. As a result of their exposure, the receiving structures also protrude above the bottom of the recess directly surrounding them or the bottom of the trench directly surrounding them.

Advantageously, the trench around a single receiving structure is at least large enough that the clear width of the trench wall surrounding the receiving structure corresponds at least to the diameter of the sample sphere to be formed.

If the receiving structures present on the structured face are arranged close enough to each other that their respective trenches touch or intersect with each other completely or partially, only the end faces and/or remnants of the trench walls remain from the original surface of the structured face.

The trench walls can also be completely eliminated in the case of complete intersection, so that only the receiving structures and optionally a border of the carrier arranged outside all receiving structures protrude at least 1 nm above the bottom of the trenches. In other words, in this configuration, the receiving structures are removed from the original surface using an abrasive method, without secondary structures such as trench wall remnants remaining between or next to the receiving structures. The optional edge can preferably serve as a support and guide for a scraper (see below) with which the produced frozen sample spheres can be removed in an automated manner from the carrier.

Similarly, in other embodiments some or all of the receiving structures may project beyond the at least one face, for example by producing the receiving structures on the face using an additive method such as a 3D printing method (for example, SLS, SLA, FDM, et cetera) or sputtering. In these embodiments, too, the receiving structures include a carrier structure at the base, which structure is configured in particular in the form of a column. Again, the column can have a round, oval or n-sided cross section, for example. The receiving structures, in turn, protrude at least 1 nm beyond the structured face.

In order to minimize the risk of two adjacent sample spheres merging, the average distance between two receiving structures (the distance between their notional center lines or longitudinal axes) is advantageously at least the same and particularly preferably at least 1.1 times the diameter of the sample spheres to be formed.

In each of the aforementioned embodiments, the formation of a sample sphere can be supported by a ratio of a diameter of the recess of the receiving structure to a diameter of the receiving structure being at least 0.7, advantageously at least 0.8 and preferably at least 0.9. This means that the receiving structure or edge (see above) projecting above the surface directly surrounding it has, from its outer side to the recess, only a very sharply defined region which is as small as possible in a direction parallel to the structured face. Such a configuration supports the formation of a sample sphere, as contact with a material of higher density-and thus potentially higher wettability-is reduced. In this way, even highly wetting reagent mixtures with a small contact angle can be safely held and frozen in the recess of the receiving structure. In addition, a coating with a hydrophobic effect, for example, can be formed on the front side of the edge or the wall of the recess.

The receiving structures can, for example, have diameters selected from a range of 0.1 mm to 20 mm. This allows, for example, volumes of liquid sample from less than 1 μl up to 4000 μl to be applied and processed. Each carrier advantageously, but not exclusively, contains receiving structures of one type and one dimension to allow efficient production of frozen sample spheres.

It is also possible to provide carriers with receiving structures of different types and/or different dimensions. Such carriers can be used, for example, to find, test and, if necessary, optimize suitable receiving structures for a specific reagent mixture (sample).

The disclosure serves not least to allow the efficient production of a large number of frozen sample spheres. For this purpose, the receiving structures are advantageously arranged in a regular pattern, in particular in rows and/or columns, on the structured face of the carrier. A regular arrangement allows, on the one hand, an advantageous use of the available extent of the structured face and, on the other hand, a predictable positioning of the recesses or the frozen sample spheres in order to be able to handle them preferably in an automated manner (see below).

For effective loading of the carrier as well as for simple and, if possible, automated detachment of the frozen sample spheres (“harvesting”), the carrier according to the disclosure is configured, for example, in the form of a plate. In order to connect a plurality of plate-shaped carriers to each other, a base body of the carrier can be configured as a rod with an n-sided cross section, wherein at least one of the n side faces is a structured face. The at least one plate-shaped carrier can be mounted interchangeably on the base body. Such a base body having a plurality of structured faces present thereon can advantageously be rotatable about its longitudinal axis in a controlled manner, so that a specific face can be delivered to a designated working position. For example, one of the faces can be loaded with liquid sample at its current position while another face is harvested at its current position.

Following the idea of a rotatable arrangement of faces, the coolable carrier according to the disclosure can be configured with a curved structured face. A curved structured face can be a cylinder portion. In order to support a unidirectional movement of a carrier with a curved face with regard to automation, the curved face can be the surface of a cylinder.

The object of the disclosure is achieved by a device for producing frozen sample spheres (cryo-beads) in addition to the carrier according to the disclosure. The device includes at least one carrier according to the disclosure and a cooling device for cooling the carrier. The cooling device can, for example, be an electrical Peltier element arranged on the carrier. Alternatively, a refrigeration machine may transport a cooling liquid to the carrier and the carrier may have cooling channels through which the coolant circulates. Cooling via liquid nitrogen or dry ice is also possible; to increase the surface area, in particular the side of the carrier facing away from the structured face (underside) can, for example, have cooling fins for this purpose. A scraper is provided to allow the separation of frozen sample spheres from the receiving structures produced during use of the device. The structured face and the scraper are arranged to be movable relative to each other, whereby the scraper can be movable along the stationary face, the structured face against the stationary scraper or both against each other.

In order to remove the frozen sample spheres from the recesses without damaging the sample spheres, the scraper can be configured with an inclined contact surface. The inclination is advantageously directed at an obtuse angle opposite to a direction of relative movement between the structured face and the scraper, so that the scraper lifts the frozen sample spheres from the respective recesses in the sense of a wedge, as will be described further below.

In a further embodiment of the device, an apparatus for the automated application of the liquid sample into the recesses may be provided and may be configured, for example, as a pipetting head, a dispenser or a multi-channel pipette system, for example a 12-channel pipette system. For example, if a pipetting head in a 16×24 format is used, 384 recesses can be filled with liquid sample at the same time. Other grids or formats such as 1×8, 8×12, 32×48 et cetera are also conceivable. Such a parallelization of the process reduces the so-called cycle time for each liquid sample to be applied to a few milliseconds in contrast to prior art methods, for example compared to dripping into liquid nitrogen.

The apparatus as well as a drive of the carrier and/or the scraper can be controlled and moved or actuated in a coordinated manner via a controller.

Preferably, the device can be operated in a controlled gas atmosphere. For this purpose, the device can have a supply with an outlet opening for a gas and optionally a housing. The feed can be rigidly directed toward the carrier or arranged to be movable. A movable feed advantageously allows the outlet opening to be adjusted over a particular pipetting position. The housing can enclose at least the carrier and optionally the scraper, the pipetting head and/or the cooling system. The gas can in particular be a protective gas or a gas mixture (including atmospheric air) having the lowest possible water content.

The carrier according to the disclosure or the device according to the disclosure can be used in a method for producing frozen sample spheres.

Such a method includes the steps of providing a carrier or a device according to the disclosure. This is followed by the application of a liquid sample to at least one of the receiving structures. The liquid sample can be applied, for example, by pipetting or dispensing. A total volume V can be applied, for example, by simultaneously dispensing a number of individual volumes corresponding to the number of receiving structures, for example via an appropriately dimensioned pipetting head, or by quickly sequentially dispensing a corresponding number of droplets with droplet volumes TV in the pL, nL or μL range at frequencies f from a few Hz to several hundred kHz). For dispensing, the combination of total volume V and repetition frequency f of the droplet volume dispensing TV is selected such that the total duration t of the total volume dispensing V is in the range t=0.01 s to t=60 s, preferably in the range t=0.5 s to t=15 seconds. Other methods of liquid transfer such as ultrasound-based transfers or others are also conceivable.

The liquid sample introduced into the respective recesses is cooled intensely so that a frozen sample sphere is created in each case. The temperature control can be achieved using, for example, liquid nitrogen, dry ice, electrical Peltier elements, refrigerant provided by a refrigeration machine, et cetera. For temperature control, the carrier itself is cooled or is cooled by direct contact of the carrier with, for example, an actively cooled base plate. The carrier, in particular in a configuration as a cylinder or n-sided column, can in further configurations be tempered by the action of a coolant (for example, liquid nitrogen, tempered (silicone) oil, et cetera) via a refrigeration machine. The coolant can flow through the carrier and does not come into direct contact with the liquid sample or the frozen sample spheres.

To harvest the frozen sample spheres, they are optionally removed from the particular receiving structure via, for example, the scraper. In further embodiments, the carrier can be oriented after the sample spheres have frozen such that they fall out of the recesses due to the force of gravity acting thereon and can be collected. For this purpose, the recesses can be provided with a coating and/or surface structure, for example, on which the frozen sample spheres cannot gain sufficient hold, for example in an inclined or overhead position.

The collected sample spheres must continue to be cooled to such an extent that they do not experience an uncontrolled increase in temperature or begin to thaw again or even thaw out completely.

The frozen sample spheres produced in this way can be stored in a cooled state and used later. However, in order to be able to store, transport and use them at temperatures above their particular freezing temperature, the sample spheres are advantageously dried, in particular lyophilized.

The advantages of the disclosure are, on the one hand, that the liquid sample and the frozen sample spheres do not come into direct contact with the coolant and thus contamination can be excluded. Frozen sample spheres can be produced with a small manufacturing-related variance in their dimensions or volume, which is of great importance for the reproducibility of applications in which the produced sample spheres are used, possibly in the dried state. Accordingly, the rejection rate is low. The efficient production coupled with a comparatively simple configuration of the manufacturing device allows the production of high-quality frozen sample spheres with small and cost-effective systems.

Via the method according to the disclosure, sample spheres can be produced, for example, selected from a diameter range of 0.5 to 20 mm and with volumes of less than 1 up to 4000 μl. In experiments, several thousand sample spheres with a volume of 10 μL each were produced as mock beads, as well as several thousand RT-qPCR beads with volumes of 5 μL, 10 μL and 25 μL, as well as several hundred LAMP beads with a volume of 10 μL each, which were then freeze-dried and functionally tested. The performance parameters after freeze-drying did not differ from the standard method. The number of cycles can reach 72,000 per hour, for example, the production of 125,000 sample spheres requires only 1.75 hours.

In their freeze-dried state, the sample spheres produced according to the disclosure can be used in particular as precursors, for example as an additive for a detection reaction or as an inactive precursor of a ready-to-use reaction mixture or a ready-to-use buffer solution, et cetera. These are used, for example, for RT-qPCR (and other PCR variants), isothermal amplification, immunoassays, enzymes and proteins, conjugated antibodies, collagens, pharmaceutical active ingredients or therapeutics or drugs, et cetera.

### BRIEF DESCRIPTION OF DRAWINGS

The invention will now be described with reference to the drawings wherein:

FIG. 1 is a schematic representation of a first embodiment of a carrier according to the disclosure;

FIG. 2 is a schematic representation of a second embodiment of a carrier according to the disclosure;

FIG. 3 is a schematic representation of a third embodiment of a carrier according to the disclosure;

FIG. 4 is a schematic representation of a fourth embodiment of a carrier according to the disclosure;

FIG. 5 is a schematic representation of a fifth embodiment of a carrier according to the disclosure;

FIG. 6 is a schematic representation of a sixth embodiment of a carrier according to the disclosure;

FIG. 7 is a schematic representation of a seventh embodiment of a carrier according to the disclosure;

FIG. 8 is a schematic representation of an eighth embodiment of a carrier according to the disclosure;

FIG. 9 is a schematic representation of a ninth embodiment of a carrier according to the disclosure;

FIG. 10 is a schematic representation of a tenth embodiment of a carrier according to the disclosure;

FIG. 11 is a schematic representation of an embodiment of a device according to the disclosure for producing frozen sample spheres;

FIG. 12 is a schematic representation of a further embodiment of a device according to the disclosure for producing frozen sample spheres and

FIG. 13 is a schematic flow diagram of an embodiment of the method according to the disclosure.

### DETAILED DESCRIPTION

The representations are schematic and not to scale. The same reference signs indicate the same technical elements in the different illustrations.

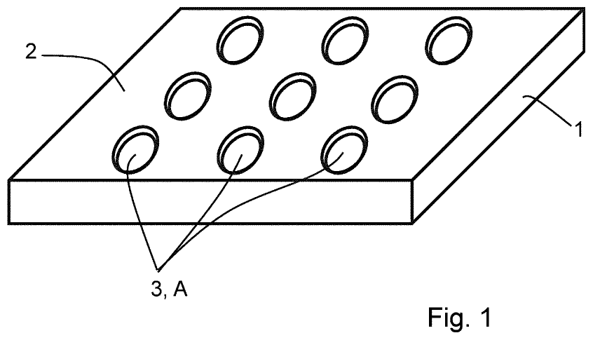

A carrier 1 according to the disclosure has at least one structured face 2, in particular a side face, in which at least one recess 3 serving as a receiving structure A is formed. In FIG. 1, three rows having three recesses 3 each are shown as an example. The recesses 3 are in particular concavely curved into the material of the carrier 1 and each represent, for example, a spherical segment.

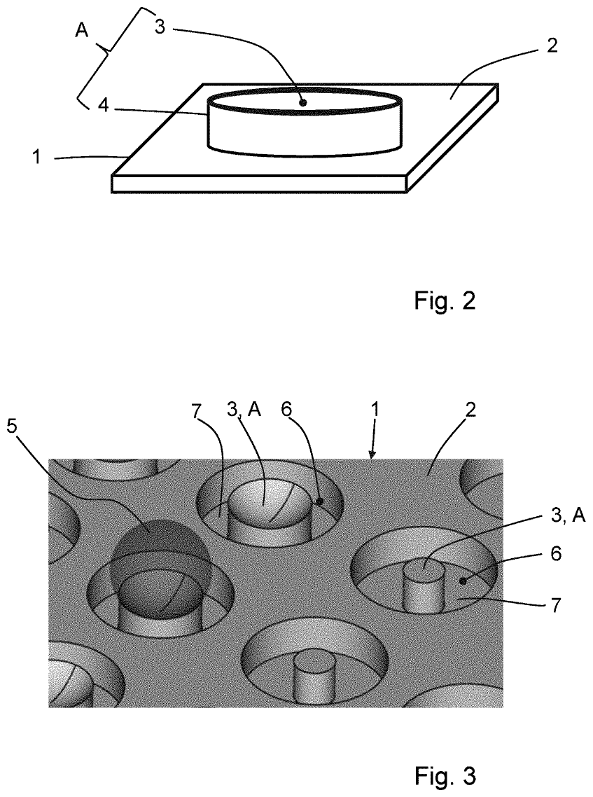

In a second embodiment, the recess 3 is surrounded by an edge 4 (FIG. 2). Recess 3 and edge 4 together form the receiving structure A. The edge 4 is kept narrow in the radial direction on its end face facing away from the structured face 2 in order to offer a small potential wetting face for a liquid sample 5 introduced into the recess 3 (see FIG. 3). In FIG. 2, only one receiving structure A is shown as an example. However, a carrier 1 can have a plurality of such receiving structures A.

In order to keep the potential wetting face small and to support the formation of the liquid sample 5 into a sphere, each of the recesses can be surrounded by a trench 6, which is created, for example, by local material removal of the structured face 2. The receiving structure A created in this way is free-standing and projects above the surface 7 directly surrounding it (bottom of the relevant trench 6). As a result of the release, the receiving structure A includes a carrier structure T arranged at the base. In FIG. 3 two different forms of receiving structures A can be seen. On the right side of the image, the receiving structure A, which remains as a column, has a comparatively small diameter and a very shallow recess 3. Such a configuration is suitable, for example, for small amounts of a liquid sample 5 and/or for reagent mixtures with a strong tendency to form spheres.

A liquid sample 5 is applied to one of the receiving structures A shown on the left in the image. Their amount and composition allow the formation of a spherical shape (sphere) due to molecular interactions. This process is further supported by the fact that the recess is shaped as a spherical segment.

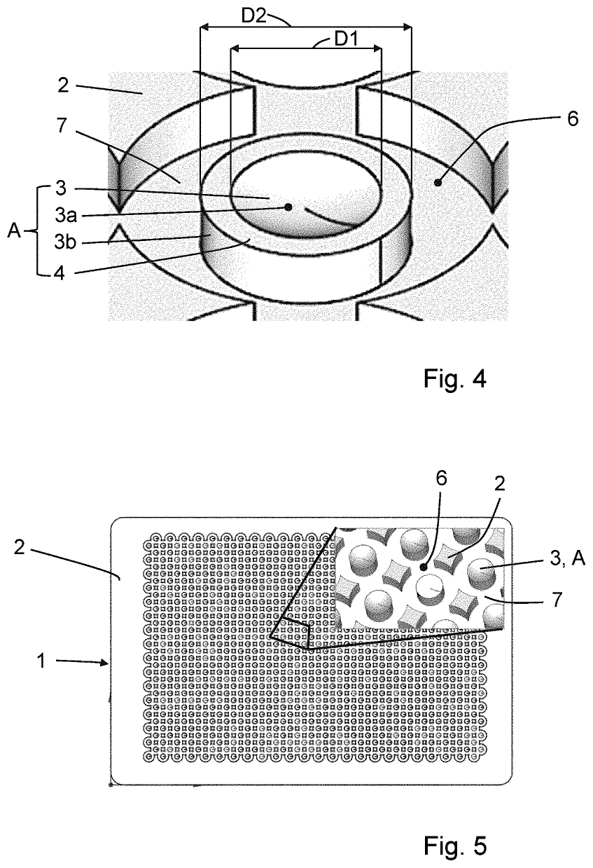

In the fourth embodiment shown in FIG. 4, the positions of the individual receiving structures A are so close to each other and the respective trenches 6 are dimensioned large enough that the trenches partially intersect with each other. In the example, a diameter D1 of the recess 3 is in a ratio of slightly more than 0.7 to a diameter D2 of the receiving structure A. The circular end face of the receiving structure A facing away from the remaining surface 7 can optionally be provided with a coating and/or surface structuring that repels the liquid sample 5.

An even more pronounced mutual intersection of the trenches 6 can be seen in a fifth embodiment in the enlarged detailed view (FIG. 5). Of the original face 2, only a few columns having pillow-shaped cross sections remain. The carrier 1 is configured as a plate in SBS format and has 768 receiving structures A for the production of frozen sample spheres 5 (FIG. 3) or 10 (cryo-beads, see FIG. 11) with 10 μl each. The receiving structures A are arranged in rows and columns, with every second one being offset from each other by the distance of a receiving structure A and a portion of the diameter of the surrounding trench 6 in the direction of the columns in order to use the available space effectively.

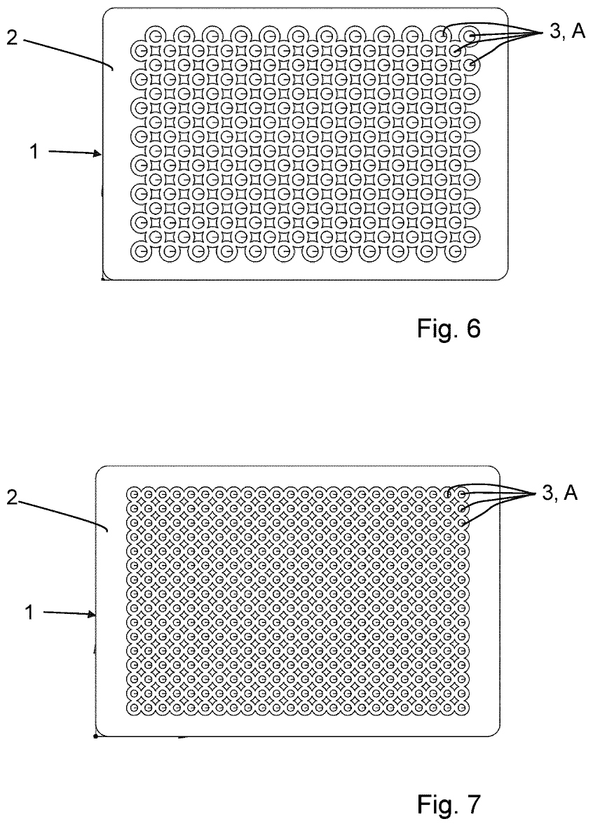

FIG. 6 shows a sixth embodiment of the carrier 1 according to the disclosure with receiving structures A which are also arranged in rows and columns and offset from each other, the trenches 6 of which partially intersect with each other. The number of receiving structures A in the example is 192.

The same basic embodiment is followed by a seventh embodiment (FIG. 7) with 384 receiving structures A.

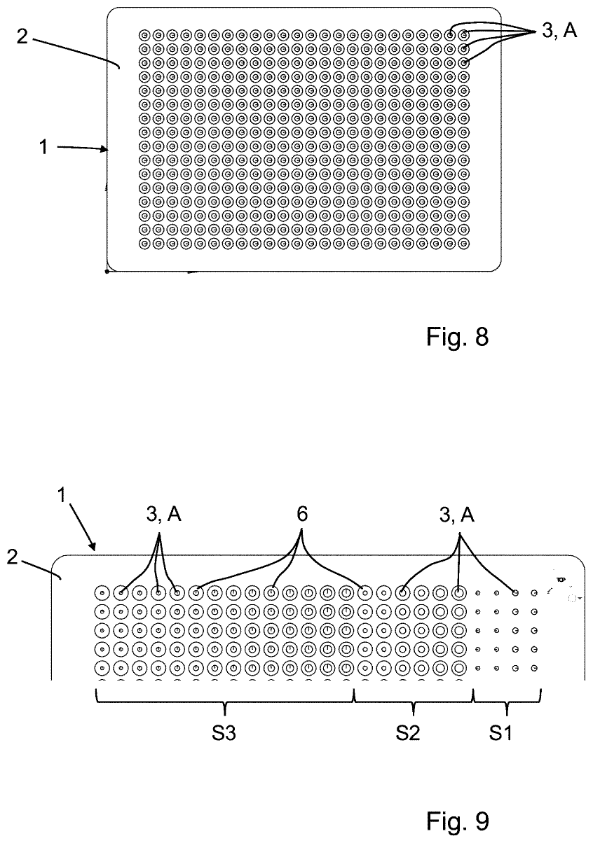

In contrast, the trenches 6 of the 384 receiving structures A do not intersect with each other according to an eighth embodiment (FIG. 8). These are arranged in rows and columns, but without being offset from each other.

Likewise, the receiving structures A or the recesses 3 on the structured face 2 of a carrier 1 that is shown as a detail in the form of a plate according to a ninth embodiment according to FIG. 9 do not have any reciprocal offset. The carrier 1 has a number of differently configured receiving structures A, wherein the receiving structures A of each two adjacent columns are the same. For the sake of clarity, the receiving structures A are assigned to one of three sections S1 to S3 in the direction of the rows. The receiving structures A of the first section S1 shown on the far right are formed as concave recesses 3 in the structured face 2.

To the left follow receiving structures A of the second section S2, each surrounded by a trench 6, whereby the trenches do not intersect with each other. The ratios of the diameters of the receiving structures A and the trenches 6, which remain constant in diameter, change every two columns, whereby the receiving structures A each have very shallow recesses 3.

In the third section S3, the receiving structures A are also surrounded by trenches 6. The ratios of the diameters of the receiving structures A and the constant-diameter trenches 6 increase to the left, that is, the diameters of the receiving structures A become smaller every two columns. The recesses 3 present on the front sides facing the viewer are concave, in particular in the form of spherical segments.

A carrier 1 configured according to the ninth embodiment can advantageously be used to determine a suitable receiving structure A for a specific reagent mixture and/or for desired volumes of the frozen sample spheres 10 to be produced. This is advantageously done taking into account the interaction with the respective manufacturing conditions, such as a particular temperature of the carrier 1 and the liquid sample 5 and a time period for the formation of a sample sphere and its complete conversion into the frozen state.

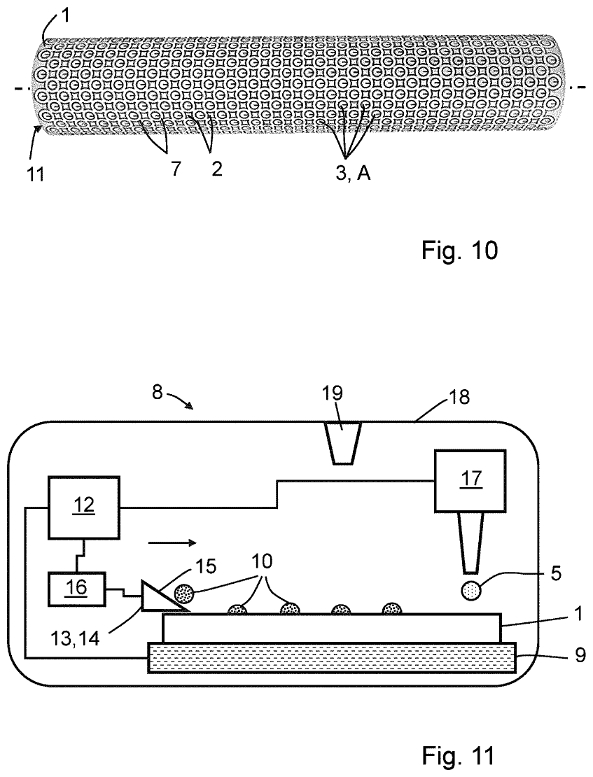

The above-described carriers 1 in the form of plates can be used in manual or automated manufacturing methods for frozen sample spheres 10. In order to promote a continuous loading of the carrier 1 with the liquid sample 5 and the harvesting of frozen sample spheres 10, according to a tenth embodiment the carrier 1 is formed with a roller-shaped or n-sided base body 11. In FIG. 10, a carrier 1 according to a tenth embodiment is shown with a roller-shaped base body 11, the outwardly facing surface of which is formed by the structured face 2. The receiving structures A are arranged in rows, with adjacent rows being offset from each other in the embodiment shown in order to achieve better utilization of the available area.

The roller-shaped carrier 1 can be present in a device 8 (see also FIG. 11). The loading of the receiving structures A with the liquid sample 5 can be carried out via an apparatus 13 configured for this purpose, which can be configured, for example, as a dispensing or pipetting head 17.

An embodiment of a device 8 for producing frozen sample spheres 10 is shown in simplified form in FIG. 11. The carrier 1 is brought to and maintained at the desired temperature via a cooling apparatus 9. The liquid sample 5 is introduced into the relevant recess 3 of a receiving structure A (see above) via an apparatus 13 implemented as a pipetting head 17 for applying the liquid sample 5 and freezes there. The frozen sample spheres 10 thus produced are removed from the recesses 3 via a scraper 14. This can be done purely mechanically via a pressing force transmitted by the scraper 14 to the frozen sample sphere 10. If the recesses 3 are configured as spherical segments, in particular as (almost) hemispherical segments, an inclined scraper 14 is advantageous. In FIG. 11, a scraper 14 is shown, the contact surface 15 of which is inclined against a relative movement with respect to the carrier 1. An existing controller 12 is connected to the pipetting head 17, a drive 16 for the scraper 14 and the cooling apparatus 9 in a manner suitable for transmitting data and controls them with control commands.

In the example, the scraper 14 is guided from left to right against the frozen sample spheres 10. The contact surface 15 of the scraper 14 is inclined to the left, so that it lifts the frozen sample spheres 10 out of the corresponding recesses 3 like a wedge without damaging the frozen sample spheres 10. A relative movement between carrier 1 and scraper 14 is generated via the drive 16.

In addition, the device 8 of FIG. 11 has a feed 19 via which a protective gas can be supplied to the carrier 1. To optimally maintain a controlled gas atmosphere, the device 8 is also provided with a housing 18.

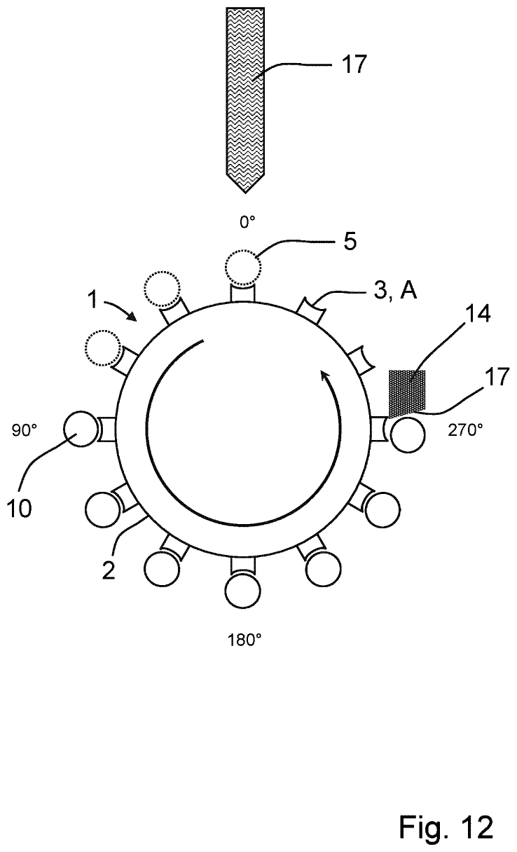

In the embodiment of FIG. 12, a device 8 is combined with a coolable roller-shaped carrier 1 (see FIG. 10). The roller-shaped carrier 1 rotates one position further after each dispensing of liquid sample droplets 5 from the receiving structures A arranged in rows on the curved structured face 2. After a rotation of ≥90° to <360°, preferably between ≥180° and <360° and ideally at 270°, the already applied and now frozen sample spheres 10 reach the preferably stationary scraper 14. As the carrier 1 continues to rotate, the sample spheres 10 are pressed against the scraper 14 and are thereby removed or harvested from the recesses 3. In this embodiment, the contact surface 15 of the scraper 14 is also inclined.

The harvested frozen sample spheres 10 can be placed in a collection container for further processing or storage. In order to be able to store, transport and use the frozen sample spheres 10 without further cooling, they are advantageously subsequently freeze-dried (lyophilized).

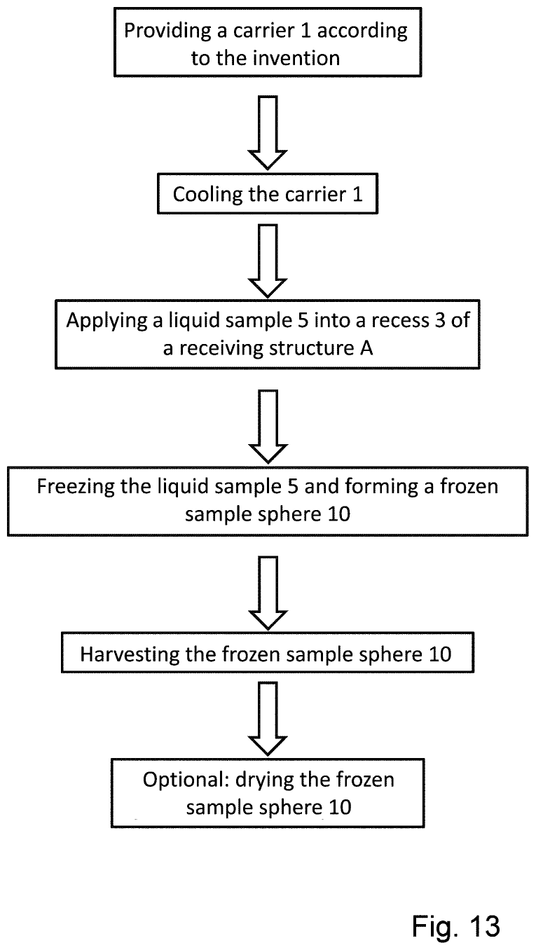

An embodiment of the method according to the disclosure is shown in FIG. 13 in simplified representation. After at least one carrier 1 according to the disclosure has been provided, it is cooled to a process temperature at which the reagent mixture to be used freezes. The process temperature is typically in a range between 10 K and 350 K, advantageously 75 K to 277.15 K. A temperature of the carrier 1 in a range of ±50 K around the melting temperature Tₘ or the eutectic temperature Tₑᵤₜ of the reagent mixture or the collapse temperature T_{C} is considered advantageous.

The corresponding volumes of liquid sample 5 are introduced into the respective recesses 3 of the receiving structures A on the carrier 1 having the desired process temperature. There, the respective volumes of the liquid sample 5 form a sphere due to molecular interactions of the ingredients, which sphere is subsequently frozen.

The frozen sample spheres 10 thus produced are harvested and subsequently optionally dried.

It is understood that the foregoing description is that of the preferred embodiments of the invention and that various changes and modifications may be made thereto without departing from the spirit and scope of the invention as defined in the appended claims.

### LIST OF REFERENCE SIGNS

1 carrier
2 structured face
3 recess
3a end face
3b carrier structure
4 edge
5 liquid sample
6 trench
7 trench bottom, remaining surface
8 device
9 cooling device
10 frozen sample sphere
11 base body
12 controller
13 apparatus
14 scraper
15 contact surface
16 drive
17 pipetting head
18 housing
19 (protective gas) supply
A receiving structure
D1 diameter of the recess 3
D2 diameter of the receiving structure 3
T carrier structure

1. A coolable carrier comprising:
said coolable carrier defining at least one structured face having a plurality of receiving structures;
each of said plurality of receiving structures being configured to receive and position a liquid sample;
each of said plurality of receiving structures defining a recess; and,
at least a portion of said plurality of receiving structures being separated from said structured face in that said portion of said plurality of receiving structures each project beyond a surface of said structured face directly surrounding said portion of said plurality of receiving structures.

2. The coolable carrier of claim 1, wherein said at least a portion of said plurality of receiving structures include a basally arranged carrier structure.

3. The coolable carrier of claim 1, wherein a trench is formed in said structured face around each of said receiving structures of said at least a portion of said receiving structures.

4. The coolable carrier of claim 1, wherein said recess is formed on an end face of each of said receiving structures.

5. The coolable carrier of claim 1, wherein said recess has a shape of a spherical segment.

6. The coolable carrier of claim 1, wherein said receiving structures have respective diameters selected from a range of from 0.1 mm to 20 mm.

7. The coolable carrier of claim 5, wherein a ratio of a diameter of the recess to a diameter of the receiving structure is at least one of the following: 0.7, 0.8 and 0.9.

8. The coolable carrier of claim 1, wherein said receiving structures are formed in rows and/or columns on the structured face.

9. The coolable carrier of claim 1, wherein said coolable carrier is configured in a form of a plate.

10. The coolable carrier of claim 1, wherein said coolable carrier comprises a base body and said base body is configured as a rod with an n-sided cross section providing a plurality of n side faces and at least one of the n side faces is said structured face.

11. The coolable carrier of claim 1, wherein said coolable carrier is formed with a curved structured face.

12. A device for making frozen sample spheres, the device comprising:
a coolable carrier including:
said coolable carrier defining at least one structured face having a plurality of receiving structures;
each of said plurality of receiving structures being configured to receive and position a liquid sample;
each of said plurality of receiving structures defining a recess; and,
at least a portion of said plurality of receiving structures being separated from said structured face in that said portion of said plurality of receiving structures each project beyond a surface of said structured face directly surrounding said portion of said plurality of receiving structures;
a cooling device for cooling said coolable carrier;
a scraper having an inclined contact surface configured to scrape frozen sample spheres present on the receiving structures; and,
wherein the coolable carrier and said scraper are movable relative to each other.

13. The device of claim 12, wherein said device has, for the purpose of operation in a controlled gas atmosphere, a supply with an outlet opening for a gas and optionally a housing enclosing at least said coolable carrier.

14. A method for making sample spheres, comprising the steps of:
providing a coolable carrier including: the coolable carrier defining at least one structured face having a plurality of receiving structures; each of the plurality of receiving structures being configured to receive and position a liquid sample; each of the plurality of receiving structures defining a recess; and, at least a portion of the plurality of receiving structures being separated from the structured face in that the portion of the plurality of receiving structures each project beyond a surface of the structured face directly surrounding the portion of the plurality of receiving structures;
applying a liquid sample to at least one of the cooled receiving structures;
freezing the liquid sample so that a frozen sample sphere is created; and,
optionally scraping the frozen sample sphere from the at least one of the cooled receiving structures.

15. The method of claim 14, wherein the sample spheres are dried.

16. The method of claim 15, wherein the sample spheres are lyophilized.

17. The coolable carrier of claim 1, wherein said recesses corresponding to said plurality of receiving structures are concave recesses.
